(19) United States
(12) Patent Application Publication
(10) Pub. No.: US 2015/0055933 A1
(43) Pub. Date: Feb. 26, 2015

(54) ADVERTISEMENT SYSTEM

(71) Applicant: LUTEC CO., LTD., Taipei City (TW)

(72) Inventor: Hung-Chen LIAO, Taipei City (TW)

(73) Assignee: LUTEC CO., LTD., Taipei City (TW)

(21) Appl. No.: 13/971,728

(22) Filed: Aug. 20, 2013

(51) Int. Cl. G06Q 30/02; H04N 5/765; G11B 31/00; H04N 5/775

(52) U.S. Cl. CPC G06Q 30/0241; H04N 5/775; H04N 5/765; G11B 31/00
USPC 386/230

(57) ABSTRACT

An advertisement system includes a display device, a storage media saving video and audio data and a controller. The controller includes a memory unit in which an operation system and application programs are installed, an output interface connected to the display device, at least one input interface connected to the storage media; and a processor processing the video and audio data sent by the application programs installed in the memory unit and converting the video and audio data to video and audio signals which are sent to the display device via the output interface to display video and audio advertisements, wherein the operation system is Android operation system.

### BACKGROUND OF THE INVENTION

1. Field of the Invention

The present invention relates to an advertisement system, and in particular to an advertisement system having Android operation system to execute application programs to play video and audio advertisement.

2. Description of the Related Art

As the traditional advertisement declines gradually, new type media is desired. The digital advertisements become more and more popular, which are characterized by their diversification, integration and precision.

Digital signage (DS) is the most popular one in digital advertisement equipments. The digital signage is an electronic display device displaying information or advertisements, and often installed in private or public places to show specific information during specific period.

The digital signage has a processor of x86 structure and windows operation system to play the video and audio advertisements. The digital signage equipment provided with x86 processors is complicated and has high price. The windows operation system coordinated with the x86 processor has high authorization fee. In addition, the windows operation system has low stabilization and need expensive and high standard network environment. The operation of windows operation system is also complicated.

### SUMMARY OF THE INVENTION

It is one object of the present invention to provide an advertisement system having a processor of advanced RISC machine structure coordinated with Android operation system to display video and audio advertisements. The advertisement system of the invention has a simple structure, occupies small space and has higher efficiency.

To achieve this object of the present invention, one embodiment of an advertisement system includes a display device, a storage media saving video and audio data and a controller. The controller includes a memory unit in which an operation system and application programs are installed, an output interface connected to the display device, at least one input interface connected to the storage media; and a processor processing the video and audio data sent by the application programs installed in the memory unit and converting the video and audio data to video and audio signals which are sent to the display device via the output interface to display video and audio advertisements, wherein the operation system is Android operation system.

In one embodiment of the present invention, the controller further comprises a graphic processing unit (GPU) cooperative with the processor to process the video and audio data.

In one embodiment of the present invention, the controller further comprises a wireless transcieving unit transmitting and receiving radio signals.

In one embodiment of the present invention, the received radio signals are sent to the processor directly and further sent to the display device via the output interface to display video and audio information.

In one embodiment of the present invention, the radio signals include video and audio data sent to the storage media, the application programs installed in the memory unit reads the video and audio data from the storage media and sends the video and audio data to the processor.

One embodiment of the present invention further includes a management server send control commands to the controller via a network to control an advertisement display procedure.

In one embodiment of the present invention, the management server controls a plurality of controllers to display identical or different advertisements in a plurality of display devices.

In one embodiment of the present invention, the controller further comprises a plurality of input interfaces comprising universal serial bus (USB) and security digital memory card (SD card).

In one embodiment of the present invention, the output interface is high definition multimedia interface (HDMI).

In one embodiment of the present invention, the processor has the advanced RISC machine (ARM) structure.

### BRIEF DESCRIPTION OF THE DRAWINGS

FIG. 1 is a block diagram of an advertisement system of the invention;

FIG. 2 is a block diagram of a controller of the advertisement of FIG. 1;

FIG. 3 is a block diagram of an operation system and application programs coordinated with a processor of the invention;

FIGS. 4-6 are schematic views of images presented by an advertisement system of the invention; and

FIG. 7 depicts an advertisement system of the invention, wherein one management server controls several controllers.

### DETAILED DESCRIPTION OF THE PREFERRED EMBODIMENT

The invention is detailed described by the following embodiment in accompany with drawings,

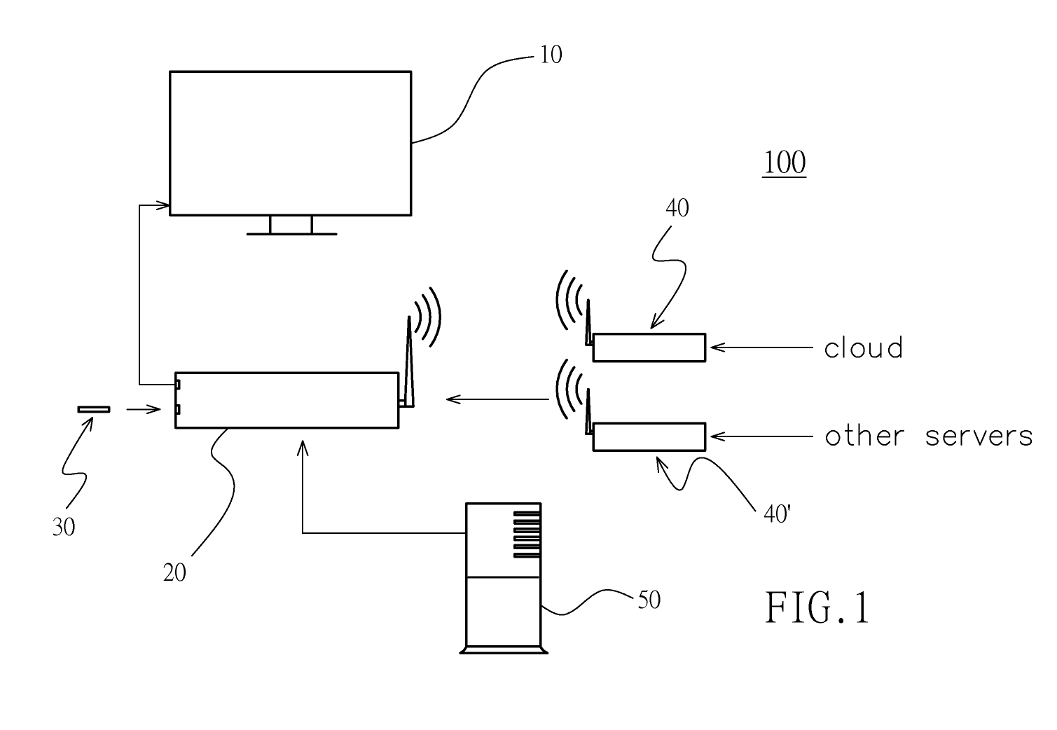

Referring to FIGS. 1, an advertisement system 100 of the invention includes a display device 10, a controller 20 and a storage media 30. Video and audio data to be played are saved in the storage media 30 and converted to video and audio signals by the controller 20, which are sent to the display device 10 to display images and music. The controller 20 reads video and audio data from the storage media 30 or receives video and audio data from a video streaming server 40 via a wireless network. The video streaming server 40 receive data from cloud. The video and audio data include video, photos or texts. The format of video can be AVI, MPEG, MP4, FLV, SWF, H.264, etc. The format of photos can be JPG, BMP, PNG, GIF etc. The format of text can be TXT. The structure of controller 20 is described as follows.

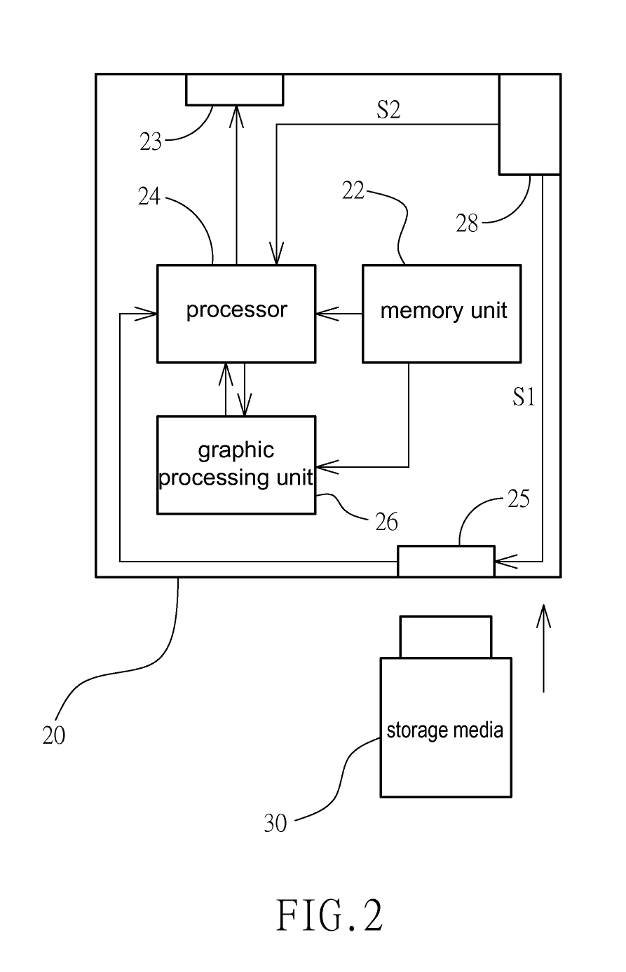

Referring to FIG. 2, the controller 20 of the advertisement system 100 includes a memory unit 22, a processor 24, a graphic processing unit 26 and a wireless transcieving unit 28. An operation system and application programs executed under the operation system are built in the memory unit 22. Video and audio data are read by the application programs and sent to the processor 24 which converts the video and audio data to video and audio signals sent to the display device 10 via an output interface 23 to display images and music. Preferably, the memory unit 22 is a read only memory (ROM) or flash memory. The graphic processing unit 26 assists the processor 24 to process video data to raise working efficiency. Preferably, the output interface 23 is video graphic array interface (VGA), digital visual interface (DVI) or high definition multimedia interface (HDMI).

The video and audio data are saved in the storage media 30. The controller 20 includes an input interface 25 to which the storage media 30 is connected. The video and audio data are sent to the processor 24 by the application programs built in the memory unit 22 for further processing or computation. The video and audio data are converted to video and audio signals and sent to the display device 10 via the output interface 23. The input interface 25 includes universal serial bus (USB) and security digital memory card (SD card).

The wireless transcieving unit 28 of the controller 20 receives video and audio data which obey real time streaming protocol (RTSP) or real time transport protocol (RTP) from a video streaming server 40.

The video and audio data S1 received by the wireless transcieving unit 28 are sent to and saved in the storage media 30 via the input interface 25 in advance. The video and audio data S1 are read by the application program, sent to the processor 24 for computation and converted to video and audio signals to display images and music in the display device 10.

In addition, the wireless transcieving unit 28 can also receive real time video and audio data S2, such as real news or weather information, via a base transceiver station 40′ from other servers. The video or audio data S2 are directly sent to the processor 24, converted to video or audio signals and displayed on the display device 10 via the output interface 23.

The processor 24 has the advanced RISC machine (ARM) structure, which is simplified, compact and high efficient. The ARM processor is easily coordinated with other computational cores, such as graphic processing unit, multimedia decoding core, baseband modem or input/output control, due to its highly integrated structure, elasticity of authorization and simple core architecture. Compared with the conventional x86 processor, the ARM processor consumes less power and therefore conserves electricity.

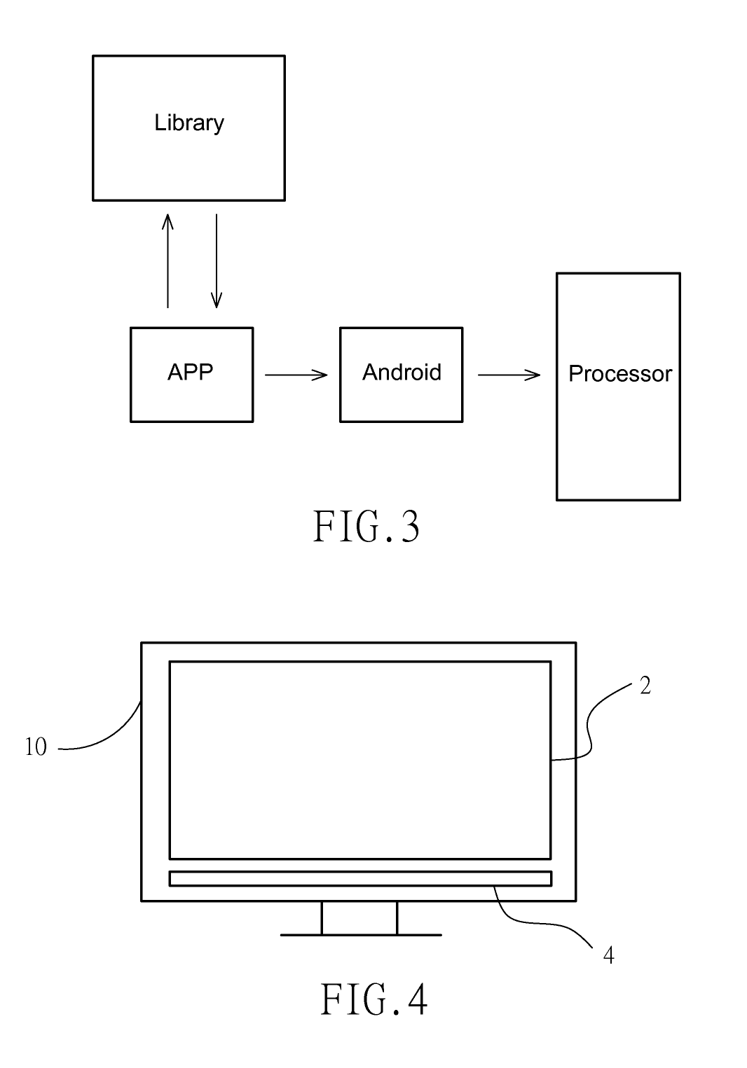

In addition, the operation system built in the processor 24 is the Android operation system, which is proud of its fast reboot, crash proof and virus defense, as shown in FIG. 3. The ARM processor coordinated with the Android operation system provides a simple, stable and easy advertisement system. The application programs of the invention executed in the Android operation system are developed by Java language or C language.

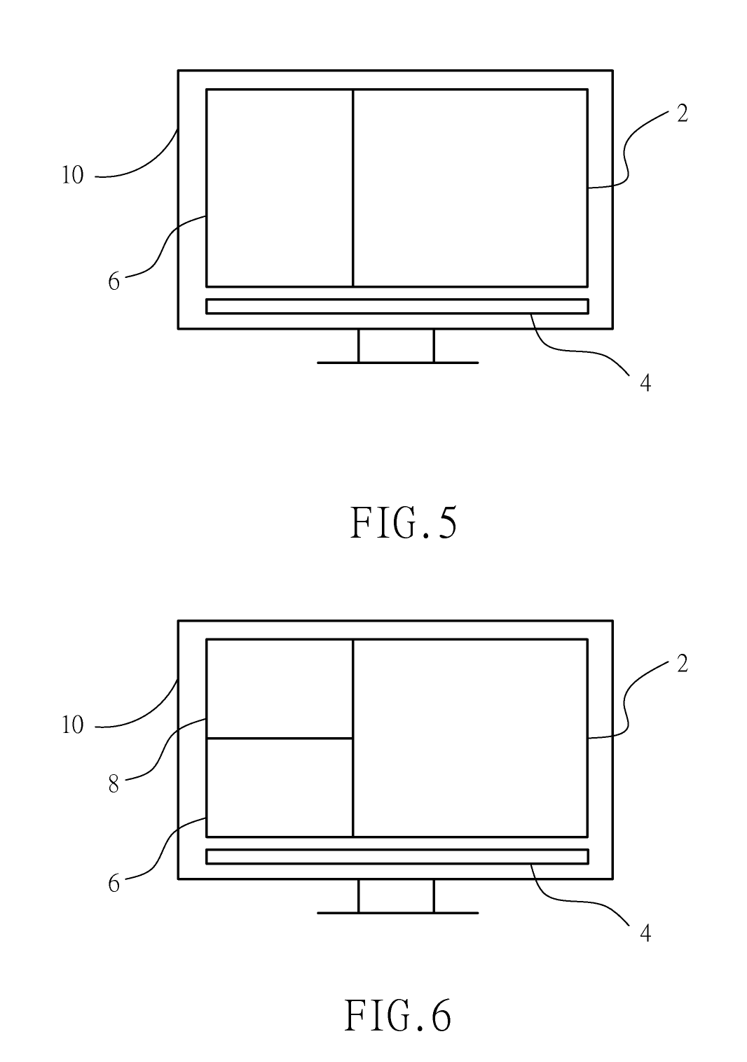

As described above, the video data include images and texts. Referring to FIG. 4, the scene displayed on the display device 10 includes an image frame 2 and a text frame 4. Video images are displayed on the image frame 2, and marquee (scrolling texts) is displayed on the text frame 4. Referring to FIG. 5, the scene displayed on the display device 10 includes two image frames 2 and 6 and a text frame 4. Video images are displayed on the image frames 2, photos are displayed on the image frame 6, and marquee is displayed on the text frame 4. Alternatively, the scene displayed on the display device 10 includes an image frame 2 and a text frame 4 as shown in FIG. 6. Video images are displayed on the image frames 2, photos are displayed on the image frame 6, real time information like weather information is displayed on the image frame 8, and marquee is displayed on the text frame 4. The display device 10 has an upright type screen or a traverse type screen. The format of the image frames and the text frame is saved in the memory unit 22. The processor 24 reads the format of the image frames and the text frame from the memory unit 22 and receives the video and audio data from the storage media 30 to display images and music on the display device 10.

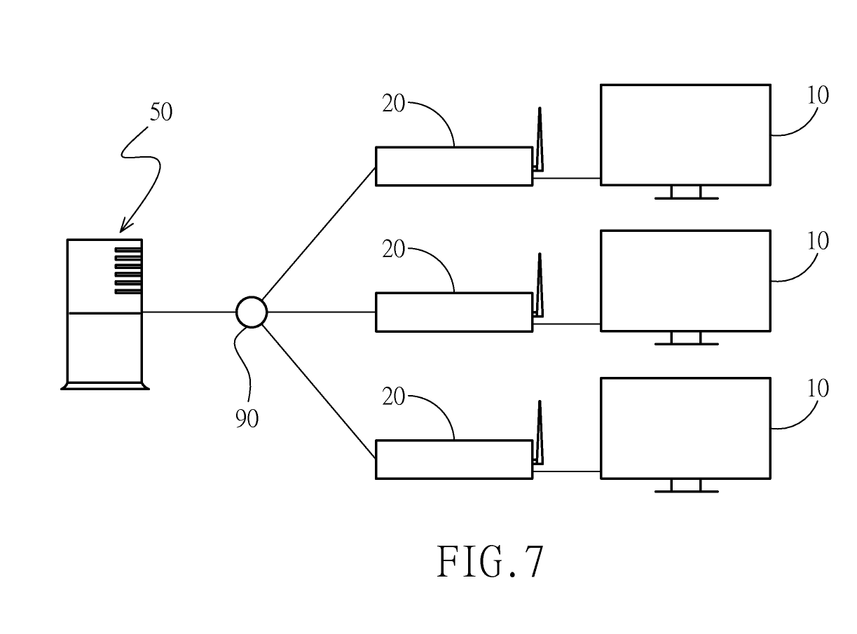

In addition, the controller 20 is connected to a management server 50 via a local area network 90. As shown in FIG. 1, the management server 50 sends control commands to the controller 20 to control an advertisement display procedure. The management server 50 is able to manage several controllers 20. As shown in FIG. 7, one management server 50 controls three controllers 20 to display identical or different advertisements in several display devices 10.

Since the advertisement system of the invention includes ARM processor and Android operation system, the memory utilization can be optimized and regulated to optimize the system operation and raise the reliability of the system.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An advertisement system, comprising:
a display device;
a storage media saving video and audio data; and
a controller comprising:
a memory unit in which an operation system and application programs are installed;
an output interface connected to the display device;
at least one input interface connected to the storage media; and
a processor processing the video and audio data sent by the application programs installed in the memory unit and converting the video and audio data to video and audio signals which are sent to the display device via the output interface to display video and audio advertisements, wherein the operation system is Android operation system.

2. The advertisement system as claimed in claim 1, wherein the controller further comprises a graphic processing unit (GPU) coordinated with the processor to process the video and audio data.

3. The advertisement system as claimed in claim 1, wherein the controller further comprises a wireless transcieving unit transmitting and receiving radio signals.

4. The advertisement system as claimed in claim 3, wherein the received radio signals are sent to the processor directly and further sent to the display device via the output interface to display video and audio information.

5. The advertisement system as claimed in claim 3, wherein the radio signals comprise video and audio data which are sent to the storage media, and the application programs installed in the memory unit reads the video and audio data from the storage media and sends the video and audio data to the processor.

6. The advertisement system as claimed in claim 1 further comprises a management server sending control commands to the controller via a local area network to control an advertisement display procedure.

7. The advertisement system as claimed in claim 7, wherein the management server controls a plurality of controllers to display identical or different advertisements in a plurality of display devices.

8. The advertisement system as claimed in claim 1, wherein the controller further comprises a plurality of input interfaces comprising universal serial bus (USB) and security digital memory card (SD card).

9. The advertisement system as claimed in claim 1, wherein the output interface is high definition multimedia interface (HDMI).

10. The advertisement system as claimed in claim 1, wherein the processor has the advanced RISC machine (ARM) structure.
